(19) United States
(12) Patent Application Publication
(10) Pub. No.: US 2002/0078003 A1
(43) Pub. Date: Jun. 20, 2002

(54) Method and system for identifying one or more information sources based on one or more trust networks associated with one or more knowledge domains

(76) Inventors: Bruce R. Krysiak, Austin, TX (US); Bijoy Goswani, Austin, TX (US)

Correspondence Address: John H. D' Antico, Brobeck, Phleger & Harrison LLP, 4801 Plaza on the Lake, Austin, TX, 78746, US

(21) Appl. No.: 09/738,258

(22) Filed: Dec. 15, 2000

(51) Int. Cl. G06F 7/00

(52) U.S. Cl. 707/1

(57) ABSTRACT

A method and system for enabling users to identify information sources based on search requests from the users, the method comprising establishment of a database that contains knowledge domains and trust networks for the knowledge domains. Both the knowledge domains and trust networks change over time according to various user inputs and search requests made to the database, enabling users to identify trusted path connections to various information sources through various entities comprising the trust network.

### STATEMENT REGARDING FEDERALLY SPONSORED

### RESEARCH OR DEVELOPMENT

### CROSS-REFERENCES TO RELATED APPLICATIONS

### MICROFICHE APPENDIX

### BACKGROUND OF THE INVENTION

1. Field of the Invention

The present invention relates generally to knowledge management, and more specifically, to a computer-based framework for facilitating person-to-person communication for information gathering tasks, such as identifying one or more top experts or other information sources in a specified knowledge domain.

2. Description of Related Art

Organizations of all sizes must continually seek to find ways to prevent entities, such as customers, employees, departments, divisions, offices, partners, subsidiaries, suppliers, and others, from proverbially reinventing the wheel. Recognizing that “it's not what you know, but who you know,” networking thus remains vital to productive and efficient work, often contributing substantially to the quality, quantity, efficiency, and effectiveness of an entity's output. As a result, many organizations have started to recognize the inherent value of an efficient knowledge sharing mechanism.

Recent advances in technology have created new opportunities that make knowledge sharing increasingly more feasible. For example, in-house bulletin boards and electronic mail (“e-mail”) systems are frequently used to allow a first entity to pose a “Does anyone know?” inquiry to the other entities in the organization. Not uncommonly, the first entity will then receive a barrage of responses, some on point and some not, to which the first entity must subsequently sort through in order to find an appropriate response, if any. If an appropriate response is received, the first entity may then notify the bulletin board or e-mail system that an answer has been obtained, effectively forcing the other entities, many of whom may be disinterested, to read the second message as well as the first, and also forcing the first entity to send the second message after they have received their desired response. Moreover, many of the received responses may contradict one another, and if the organization is sufficiently large, the first entity may not know many of the responding entities. If the responding entities are not known or efficiently knowable to the first entity, it may be impossible for the first entity to accurately access the merits of the received responses. For these reasons and others, it is commonly recognized that widely-disseminated e-mail communications quickly become obnoxious. By a single user's quest for a desired information source, tens to hundreds to thousands or more of disinterested users may have to be interrupted and may thus become annoyed. Over time, persons learn to ignore and distrust these general information seeking requests. Many individuals may develop an aversion to reading them at all, oftentimes leaving the knowledge-seeking entity without access to the organization's most valuable resources. Even with various Newsgroups, which can decrease or eliminate the disruptive and annoying aspects of widely-disseminated e-mail communication—by asking only people who want to read an information request or message to do so—not uncommonly, the person with the most valuable information within the organization may be one of the least likely persons to consult the Newsgroup.

Other traditional knowledge sharing mechanisms, such as GroupWare, best practice seminars, technology fairs, multi-disciplinary teams, cross-training key employees, and so-called knowledge databases have similar drawbacks. For instance, a traditional knowledge database or other central warehouse of knowledge may, at least conceptually, house all or part of an organization's collective social knowledge. Because knowledge is an amphorous concept, the intuitive appeal of documenting, sorting, and storing it in a central database is understandably appealing. In practice, however, while knowledge seekers are expected to enter the database and exit with desired information, such databases are commonly underutilized. As a result, other and new entities may continue to resist sharing their knowledge with the database primarily because little, if any, personal benefit can result from submitting information to the database when it is to be accessed by other entities with whom the submitting entity may have minimal contact, connection, or interaction. As a result, corporate managers have been forced to adopt incentive programs in order to solicit feedback and submissions to knowledge databases, such as those described in U.S. Pat. No. 5,924,072 to Havens. Still, knowledge databases, with their document-oriented approaches, do not facilitate the often desired person-to-person communication that is required for most meaningful information gathering tasks.

In addition, most users often do not know where to look within a traditional “ask a knowledge database” program to find a needed information source. Thus, finding a direct answer to a direct question tends to be slow, frustrating, and unreliable, despite the traditional indexing services of the knowledge database. Moreover, much information may not be made available to the database because of various economic, social, political, or other reasons. Indeed, the worth of a given piece of information may derive, at least in part, from the fact that it is not commonly known or readily accessible.

Additionally, many types of knowledge cannot be easily captured in a document format. Traditional systems are thus unable to monitor this tacit knowledge. One attempt is made in U.S. Pat. No. 6,115,709 to Gilmour et al., in which a referral database is generated by analyzing e-mail communication patterns. More specifically, pre-defined terms are extracted from intercepted e-mail messages in order to develop and support a user profile for subsequent manipulation in a knowledge database.

However, most traditional categorization schemes are static and maintained by a central entity as opposed to its everyday users, leading to slow and systemic responses towards acknowledgment and tracking of current knowledge domains that are truly relevant to an organization. When the categorization is maintained by the central entity, artificial limits are imposed regarding what is tracked and monitored. What is needed, therefore, is decentralized, dynamic knowledge management methods and systems that can rapidly recognize new developing areas of expertise within an organization and also de-emphasize areas of expertise that have become less important to the organization as a whole.

No single person or team can possess all the requisite knowledge and experience needed to accurately make correct decisions all the time. Thus, efficient, scalable, interactive, and dynamic knowledge sharing methods and systems are needed that can facilitate person-to-person communication.

Furthermore, the downfall of many traditional network mechanisms can be linked to entities who, after successfully providing counsel, fail to receive acknowledgement from those entities that sought counsel. In order to avoid the ill-fated consequences of failing to give and receive proper credit, the needed methods and systems should track whether acknowledgement was provided from a first entity that consults a second entity. Such acts of acknowledgement can solidify the consulted entity's standing within the organization and ensure availability for subsequent crises and other situations.

### BRIEF SUMMARY OF THE INVENTION

According to the present invention, many of the disadvantages and problems previously associated with knowledge management have been substantially reduced or entirely eliminated. According to one embodiment of the present invention, a user identifies information sources based on search inquiries through a method comprising a step of establishing a database containing: i) one or more knowledge domains wherein at least one of the knowledge domains contains a grouping of one or more items having at least one commonality; and ii) one or more trust networks associated with the knowledge domains wherein the trust networks comprise one or more entities providing self-evaluations and peer-evaluations of said information sources. Through the inventive methods and systems, search requests are then applied to the database and the database is accessed in response to the requests, yielding a response that is provided to the user.

The database of the present invention is dynamic in that both its knowledge domains and related trust networks change and evolve over time. Changes to both are driven by the users of the invention. Through various feedback mechanisms, the database evolves dynamically by continually monitoring and identifying the more important knowledge domains and those entities that are experts within each given knowledge domain.

The present invention eliminates the user's need to wade through numerous e-mail responses in conjunction with a widely-disseminated request for an information source. It also eliminates a user's reliance on Newsgroups to located desired information. It efficiently and explicitly addresses the problem of expertise location within an organization. It allows a database to learn from the types of information sources that users search for. It recognizes that the true value of most corporate information is the way in which it connects people to people, allowing them to share their expertise at the moment of inquiry, thus realizing and appreciating that cutting-edge thinking is always changing in a way that a traditional, static, and centrally-maintained knowledge database cannot capture. It accepts search requests for an information source and provides a path connection to the information source based on a computed trust probability that the information source will be deemed reliable. The computed probability reflects an individual's self-evaluation and various peer-evaluations in a given knowledge domain. The present invention thus facilitates the selection of an expert within an organization by identifying various knowledge domains and the experts therewithin, and then providing a most trusted path connection from that user to that expert through the trust network.

The foregoing and other objects, advantages, and aspects of the present invention will become apparent from the following description. In the description, reference is made to the accompanying drawings which form a part hereof, and in which there is shown, by way of illustration, a preferred embodiment of the present invention. Such embodiment does not necessarily represent the full scope of the invention, however, and reference must also be made to the claims herein for properly interpreting the scope of this invention.

### BRIEF DESCRIPTION OF THE SEVERAL VIEWS OF THE DRAWINGS

FIG. 1 is a simplified illustration of a client-server environment in which a preferred embodiment of the present invention may be practiced;

FIG. 2 is a representative site map by which a preferred embodiment of the present invention may be practiced;

FIG. 3 is a representative user screen illustrating a preferred embodiment of a home page in accordance with a preferred embodiment of the present invention;

FIG. 4 is a representative user screen illustrating a preferred embodiment of a logged-in home page in accordance with a preferred embodiment of the present invention;

FIG. 5 is a representative user screen illustrating a preferred embodiment of a knowledge hierarchy page;

FIG. 6 is a representative user screen illustrating a preferred embodiment of a profile page in accordance with a preferred embodiment of the present invention;

FIG. 7 is a representative user screen illustrating a preferred embodiment of a profile management page in accordance with a preferred embodiment of the present invention;

FIG. 8 is a representative user screen illustrating a preferred embodiment of a skill referrals management page in accordance with a preferred embodiment of the present invention;

FIG. 9 is a representative user screen illustrating a preferred embodiment of a myGuide page in accordance with a preferred embodiment of the present invention;

FIG. 10 is a representative user screen illustrating a preferred embodiment of a search results page in accordance with a preferred embodiment of the present invention;

FIG. 11 is a representative example of a trust network in an organization;

FIG. 12 is a representative example of the trust network of FIG. 11 in which a new self-evaluation and new peer-evaluation are depicted;

FIG. 13 is a representative example of the trust network of FIG. 11 in which a new relationship and trust rating are depicted;

FIG. 14 is a representative example of the trust network of FIG. 11 in which new entities have been added to the trust network;

FIG. 15 is a representative example of a knowledge hierarchy comprised of two knowledge domains;

FIG. 16 is a representative example of the knowledge hierarchy of FIG. 15 comprised of two additional knowledge domains;

FIG. 17 is a representative example of the knowledge hierarchy of FIG. 16 in which a new knowledge domain has been added to the knowledge hierarchy in response to search requests;

FIG. 18 is a representative example of the knowledge hierarchy of FIG. 16 in which a knowledge domain is subdivided into two additional knowledge domains;

FIG. 19 is a representative example of the knowledge hierarchy of FIG. 16 in which two knowledge domains are subsumed into a single knowledge domain;

FIG. 20 is a representative example of the knowledge hierarchy of FIG. 16 in which a knowledge domain is relocated within the knowledge hierarchy;

FIG. 21 is a representative example of the knowledge hierarchy of FIG. 16 in which previously unrelated domains become linked; and

FIG. 22 is a representative example of the knowledge hierarchy of FIG. 16 in which two knowledge domains are merged into a single knowledge domain.

### DETAILED DESCRIPTION OF THE INVENTION

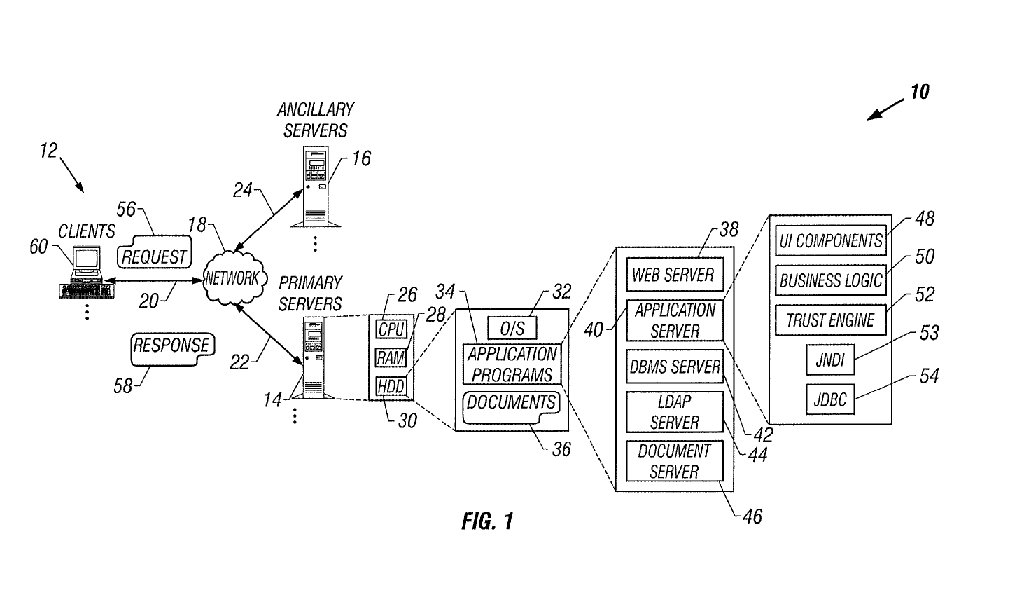

Referring now to FIG. 1, a client-server environment 10 is depicted in which a preferred embodiment of the present invention may be practiced. More specifically, one or more clients 12, primary servers 14, and ancillary servers 16 are operatively connected to one another through a communications network 18 via a respective network connection 20, 22, 24. Each network connection 20, 22, 24 is preferably a bi-directional electrical connection and includes direct and indirect communication techniques presently known or later developed. For example, each network connection 20, 22, 24 is preferably implemented by a high-speed T-1 line, an asynchronous digital subscriber line (“ADSL”), cable, wireless, or other communication connection. In a preferred embodiment, each network connection 20, 22, 24 is a presently known or later developed secure network connection, such as a secure socket layer (“SSL”) or transport layer security (“TLS”) protocol.

In a preferred embodiment, the communications network 18 is a non-publicly accessible network such as a local area network (“LAN”), metropolitan area network (“MAN”), or wide area network (“WAN”), or a full-time, publicly accessible network such as an Internet. The clients 12, primary servers 14, and ancillary servers 16 are positioned physically remote or local to one another. In addition, although only one client 12, one primary server 14, and one ancillary server 16 are depicted for ease of illustration, the invention is not limited in this regard. For example, while the invention is preferably implemented by a single primary server 14, one of ordinary skill in the art will appreciate that the invention may also be implemented by multiple primary servers 14 operating either alone or in conjunction with one or more of the ancillary servers 16. In addition, the present invention is preferably implemented in an Internet-based client-server environment 10, although the invention is not limited in this regard.

As described, the arrangements are preferably implemented by a general purpose primary server 14 executing standalone native code or a Java servlet. By selectively activating or reconfiguring the general purpose primary server 14 by techniques known in the art, the described functionality is preferably implemented without other modifications to the clients 12, primary servers 14, or ancillary servers 16. Nevertheless, without departing from the spirit or scope of the invention, those of ordinary skill in the art will recognize that the inventive arrangements can also be carried out in hardware, firmware, or in a more specialized computer server that is constructed to perform as described.

The primary server 14 preferably includes a central processing unit (“CPU”) 26, an internal memory device 28 such as a random access memory (“RAM”), and a fixed storage device 30 such as a hard disk drive (“HDD”) or other fixed storage device. The fixed storage device 30 preferably stores therein an operating system (“O/S”) 32, one or more application programs 34, and one or more documents 36. Preferred application programs 34 include a web server 38, an application server 40, a data base management systems (“DBMS”) server 42, a lightweight directory access protocol (“LDAP”) server 44, and a document server 46. A preferred application server 40 operates under the control of a set of user interface (“UI”) components 48 and business logic 50, including a trust engine 52, and preferably connects to external services such as the LDAP server 44 via connections such as a Java Naming and Directory Interface (“JNDI”) 53 and a Java Database Connectivity (“JDBC”) connection 54.

More specifically, a representative primary server 14 includes an IBM Netfinity server available from International Business Machines of Armonk, N.Y., or a NetServer available from Hewlett-Packard of Palo Alto, Calif. As a part thereof, the internal memory device 28 is primarily used for rapid execution within the CPU 26 of the various application programs 34. While the application program 34 is preferably stored within the fixed storage device 30 until it is required by the CPU 26, the invention is not limited in this regard, and the application program 34 may be stored in another computer memory, for example in a removable memory such as a floppy disk for use with a floppy disk drive or an optical disk for use with a CD-ROM.

A representative O/S 32 is the Red Hat Linux operating system available from Red Hat, Incorporation of Durham, N.C. However, the invention is not limited in this regard and can utilize other types of operating systems such as Windows and Windows NT operating systems, both of which are available from Microsoft Corporation of Redmond, Wash.

Generalizing, the described functionality is preferably implemented in software that is executed by the CPU 26 as a set of instructions or program code contained in one or more of the application programs 34. Thus, the application program or programs 34 of the present invention are preferably implemented by a computer programmer of ordinary skill in the art employing well-known computer communication methods such as methods relating to the TCP/IP communications protocol.

As stored within the fixed storage device 30, the one or more documents 36 are utilized by the one or more application programs 34 when the application programs 34 are executed by the CPU 26. Although generically termed, the documents 36 include textual, database, audio, graphic, and other files, as well as other information sources such as persons, webpages, trade journals, and others; they are preferably stored within the primary server 14, one or more of the ancillary servers 16, or elsewhere.

In a preferred embodiment, the application programs 34 includes both a web server 38 and an application server 40. A representative web server 38 includes an Internet Information Server available from International Business Machines of Armonk, N.Y.; it holds and manages the execution of the application programs 34 of the present invention. Although FIG. 1 depicts the web server 38 and application server 40 as separate application programs 34, the invention is not limited in this regard, as one can be combined with the other to form a more complex, composite application program 34. In addition, FIG. 1 depicts the various servers 38-46 as residing on a single primary server 14, although the invention is not limited in this regard and each individual server 38-46 may also reside on physically distinct primary servers 14 connected to one another via the electrical connections 22 to the communications network 18.

In operation, a user at the client 12 establishes a network connection 20 with the communications network 18 in order to transmit a search request 56 for a document 36 preferably stored within the fixed storage device 30. In response, the primary server 14 establishes its electrical connection 22 with the communications network 18 in order to service the transmitted search request 56 by providing a response 58 to the requesting client 12 via the communications network 18. Responses 58 may comprise an error response if a search request 56 cannot be serviced by the primary server 14, but for illustrative purposes, it will be assumed that the primary server 14 can provide a requested document 36 as a response 58 to a search request 56 from a requesting client 12. In a preferred embodiment, the UI components 48 include one or more Java server page components that control the directing of the client's search requests 56 to the appropriate business logic 50, and then format the response 58 for display on a monitor device 60 to the user at the client 12.

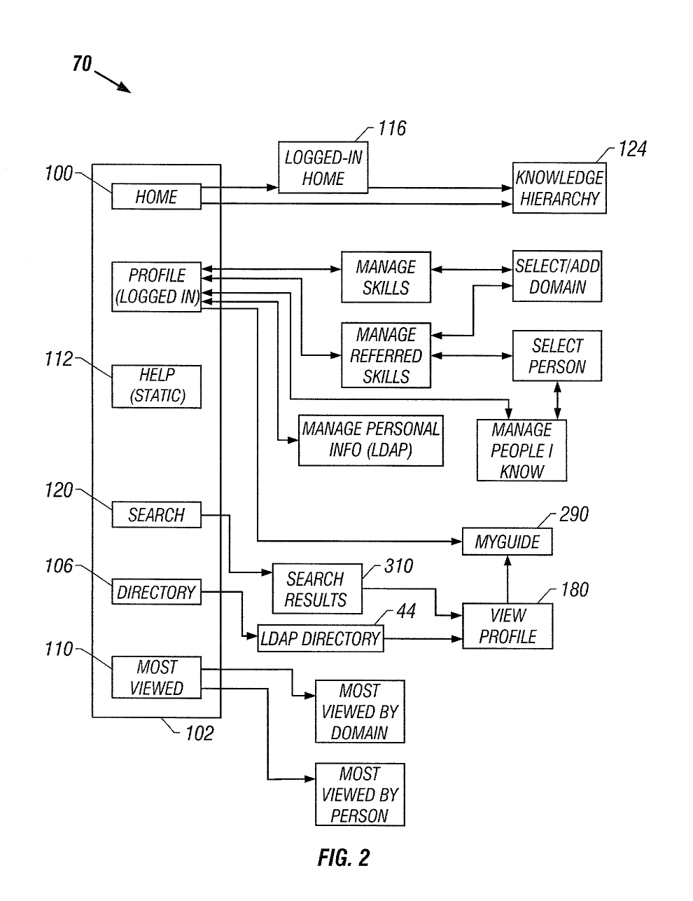

The application program or programs 34 of the present invention, which are executed by the primary server 14, include appropriate display routines for generating a set of display screens that together comprise the user interface for the invention. Accordingly, FIG. 2 is a representative site map by which a preferred embodiment of the present invention is practiced. The site map 70 is depicted as a collection of nodes with pairs of nodes interconnected by various lines. Each node of the site map 70 represents a respective content object of the site and corresponds to a respective URL. Examples of URLs that may exist within a typical web site include the HTML documents 36 (commonly referred to as web pages), image files (e.g., GIF and PCX files), mail messages, Java applets and aglets, audio files, video files, information sources, and other applications. In the preferred embodiment, the lines that interconnect nodes preferably represent links between URLs, as is well understood in the art. The functions that are performed by these links vary according to the URL type. For example, a link from one HTML document 36 to another HTML document 36 is preferably accomplished by a hyperlink that allows the user to jump from one document 36 to another document 36 while navigating the web site with the user's browser at the client 12. While navigating a particular display screen of the site, the user can then retrieve a particular URL document 36 from the primary server 14, for example by so-called “double-clicking” on the URL icon that corresponds to the sought-after document 36.

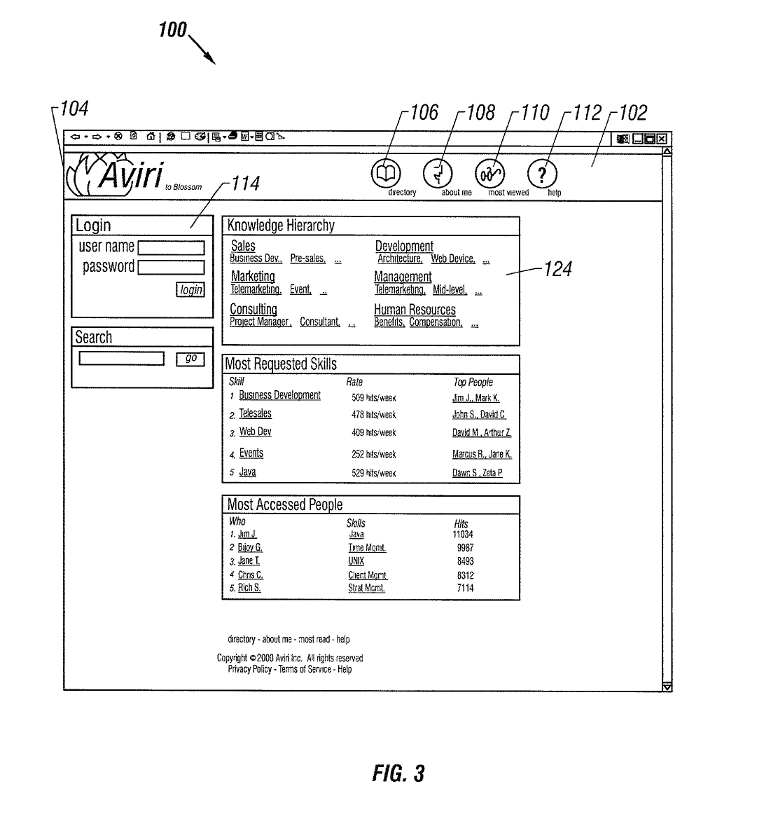

FIGS. 3-10 represent preferred display screens, although the invention is not limited in this regard. More specifically, FIG. 3 represents a user interface illustrating a Home page 100 for the web site of the present invention. A user navigates to this Home page 100 in the usual manner, i.e., by entering the URL for the page in the user's browser at the client 12, or by activating a bookmark, link, or otherwise.

Within a system bar 102 of the Home page 100, the following links are preferably provided: a Home page hyperlink 104, a Directory hyperlink 106, an About Me hyperlink 108, a Most Viewed hyperlink 110, and a Help hyperlink 112. Each hyperlink 104-112 navigates the user to a proper web page. For example, the Home page hyperlink 104 returns the user to the Home page 100 when activated. The Directory hyperlink 106 lists the skills and their respective owners within the organization. The About Me hyperlink 108 allows users to manage their profiles, skills, and guides. The Most Viewed hyperlink 110 allows users to view the most frequently viewed items and peoples, and to sort that information as desired. The Help hyperlink 112 allows users to obtain help about the application.

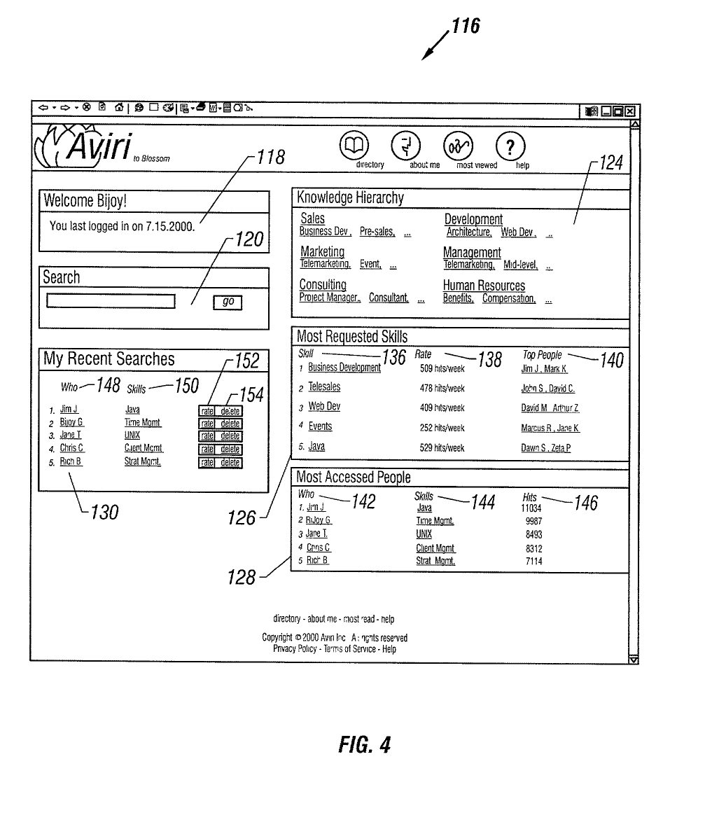

Also contained on the Home page 100 is a Log-in screen 114 that allows the user to log into the application program 34 by entering a valid user name and password. After a successful log-in, the user is presented with the Logged-in Home page 116 of FIG. 4.

The Logged-in Home page 116 includes a Logged-in screen 118 that identifies the particular user that has logged onto the web site. Also displayed is a Search screen 120, a Knowledge Hierarchy screen 124, a Most Requested Skills screen 126, a Most Accessed People screen 128, and a My Recent Searches screen 130.

As shown in FIG. 2, the user may access the Knowledge Hierarchy screen 124 from either the Home page 100 or the Logged-in Home page 116. The Knowledge Hierarchy screen 124 is preferably categorized by one or more knowledge domains. In the context of this specification, a knowledge domain refers to a grouping of one or more items having at least one commonality. For example, a Business Development knowledge domain and a Pre-sales knowledge domain may be subsets of a Sales knowledge domain, having “sales-related” commonality therebetween. Knowledge domains, and their hierarchical orderings, are explained in further detail in conjunction with FIGS. 15-22.

The Most Requested Skills screen 126 is preferably categorized by three categories, including a Skill category 136, a Rate category 138, and a Top People category 140. The Skill category 136 displays the most frequently accessed knowledge domains. The Rate category 138 displays the corresponding number of times the most frequently accessed knowledge domain are accessed. The Top People category 140 displays the corresponding names of individuals who are consulted the most often about the most frequently accessed knowledge domains. The Most Requested Skills screen 126 thus allows a user to identify those knowledge domains that are in the greatest demand within the organization, and the names of those individuals who are consulted the most often about that knowledge domain. By monitoring and tracking this information, users can tailor their skill sets to meet the continually changing demands of the organization. Monitoring and updating the information on this Most Requested Skills screen 126 is accomplished in conjunction with the Search screen 120, as will be elaborated upon below.

The Most Accessed People screen 128 is categorized by three categories, including a Who category 142, a Skills category 144, and a Hits category 146. The Who category 142 displays the names of individuals who are consulted the most often within the organization. The Skills category 144 displays the corresponding knowledge domains about which the individuals who are consulted the most often 142 are consulted. The Hits category 146 displays the corresponding number of times that the individuals are consulted. The Most Accessed People screen 128 thus allows an entity to identify those individuals that are consulted the most often within the organization and the knowledge domains about which they are consulted. The more an individual is consulted, the more that individual will become recognized as an expert within the organization.

The My Recent Searches screen 130 is categorized by two categories, including a Who category 148 and a Skills category 150. The Who category 148 displays the names of individuals whom the user that is identified in the Logged-in screen 118 most recently consulted. The Skills category 150 displays the corresponding skill about which that individual was consulted. In the preferred embodiment, the My Recent Searches screen 130 prompts users to evaluate entities whom they have consulted. Such users are continually reminded to provide this evaluative feedback until they actually do so or affirmatively decide not to do so. For this purpose, a Rate link 152 and Delete link 154 are included as part of the My Recent Searches screen 130. The Rate link 152 allows the user to evaluate the consulted entity, and if the user elects to not provide feedback, the Delete link 154 is activated.

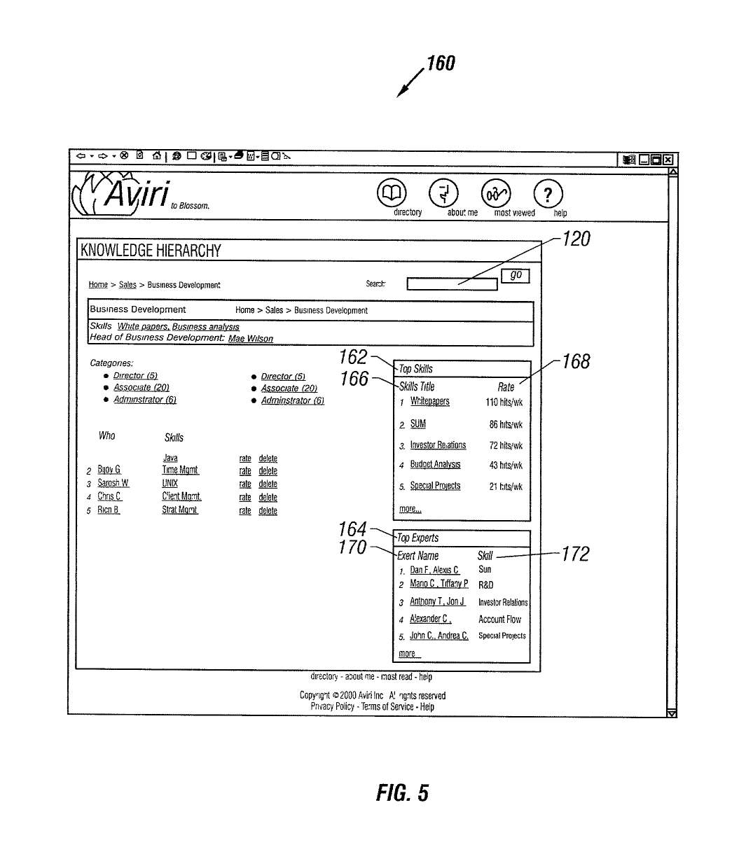

The Knowledge Hierarchy screen 124 is linked to a Knowledge Hierarchy page 160, which is shown in FIG. 5 and which provides a breakdown of the various knowledge domains. By this Knowledge Hierarchy page 160, the users use their browsers and search requests to identify the organization's experts or information sources via web links. More specifically, the Knowledge Hierarchy page 160 includes a Top Skills screen 162 and a Top Experts screen 164 for each knowledge domain. The Top Skills screen 162 is categorized by two categories, including a Skill Title category 166 and a Rate category 168. The Skill Title category 166 displays the corresponding titles of various skills that are associated with a given knowledge domain. The Rate category 168 displays the corresponding number of times that a particular skill is called upon by the entities of the organization. The Top Experts screen 164 is categorized by two categories, including an Expert Name category 170 and a Skill category 172. The Expert Name category 170 displays the corresponding names of the individuals who are consulted the most often about a particular knowledge domain. The Skill category 172 displays the skills that the corresponding individuals possess.

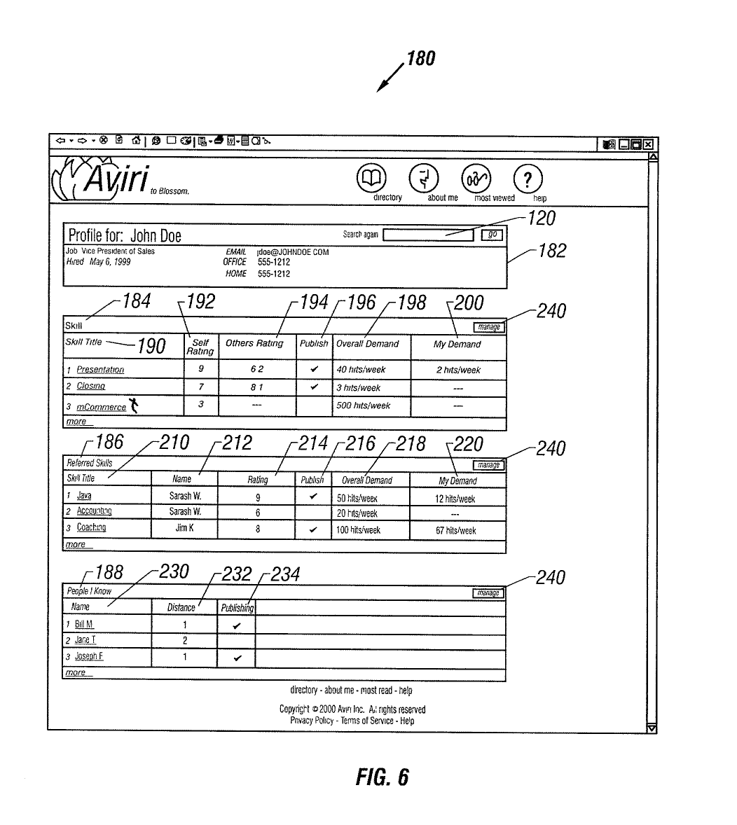

A Profile page 180, as representatively depicted in FIG. 6, is linked to each participating individual within the organization, for example by the individuals in the Top People category 140, the Who category 142, 148, and the Expert Name category 170 of FIGS. 4-5, or the About Me 108 hyperlink of FIG. 3. From anywhere within the website, if a user clicks on a hyperlink of a displayed individual's name, that individual's Profile page 180 is displayed at the user's monitor device 60 at the client 12.

The Profile page 180 displays contact or other information 182 about an individual, such as the individual's job title, date of hire, e-mail address, or phone number. In addition, the Profile page 180 includes a Skill screen 184, a Referred Skills screen 186, and a People I Know screen 188. Thus, the Profile page 180 allows users to track, manage, and build relationships, to display expertise for a given knowledge domain, and otherwise enable the users to manage their skills.

The Skill screen 184 is preferably categorized by six categories, including a Skill Title category 190, a Self Rating category 192, an Others Rating category 194, a Publish category 196, an Overall Demand category 198, and a My Demand category 200. The Skill Title category 190 displays the titles of various skills comprising the various knowledge domains. The Self Rating category 192 displays a self-evaluation of a user within a given knowledge domain. In the preferred embodiment, the self-evaluation is rated on a numeric scale of 1-10, with higher numbers referring to a greater self-evaluation, although the invention is not limited in this regard. It allows a user to report how much of an expert the user believes the user is regarding a particular knowledge domain, and thus enables a user to track the user's skill development over time. The Others Rating category 194 displays a peer-evaluation of a user within a knowledge domain, as adjudged by other entities within the organization. It preferably comprises a composite peer-evaluation. In the preferred embodiment, the peer-evaluation is rated on a numeric scale of 1-10, with higher numbers referring to a greater peer-evaluation, although the invention is not limited in this regard. It allows the other entities of the organization to report on how much of an expert these entities believe a particular user is regarding a particular knowledge domain. The self-evaluation 192 and peer-evaluation 194 may be the same or different depending on how a user judges his ability within a particular knowledge domain as compared to how the other entities rate that user within that knowledge domain. For instance, if a user does not believe that the user is an expert in a given knowledge domain, the Other Rating category 194 may reveal that other individuals within the organization regard the user as otherwise.

As indicated in the Publish category 196, the user may elect whether to publish a self-evaluation 192 per a given knowledge domain. In a preferred embodiment, it is up to an individual user to decide whether their self-evaluation 192 is made known to the other entities within the organization. In addition, the Overall Demand category 198 displays the corresponding number of times that a particular skill is called upon by the entities of the organization. Finally, the My Demand category 200 displays the corresponding number of times that a particular skill is called upon by the entities of the organization for the particular individual being profiled.

The Referred Skills screen 186 is categorized by six categories, including a Skill Title category 210, a Name category 212, a Rating category 214, a Publish category 216, an Overall Demand category 218, and a My Demand category 220. It enables each user to track and manage other people's skills that the user has used. This Referred Skills screen 186 allows an individual to track and monitor the user's personal network of individuals that the user can call upon to help complete a given task or otherwise provide needed information. By managing relationships from the Referred Skills Screen 186, the user can learn ways to be more productive in shorter amounts of time.

The Skill Title category 210 preferably displays the titles of various skills comprising the various knowledge domains. The Name category 212 displays the name of an individual with that skill for a given knowledge domain. The Rating category 214 displays an evaluation of a user within a knowledge domain, as adjudged by other entities within the organization. In the preferred embodiment, the evaluation is rated on a numeric scale of 1-10, with higher numbers referring to a greater self-evaluation, although the invention is not limited in this regard. As indicated in the Publish category 216, the user may elect whether to publish Referred Skills information 186 per a given knowledge domain. In addition, the Overall Demand category 218 displays the corresponding number of times that a particular skill is called upon by the entities of the organization. Finally, the My Demand category 220 preferably displays the corresponding number of times that a particular skill is called upon by the entities of the organization for the particular individual being profiled.

The People I Know screen 188 is categorized by three categories, including a Name category 230, a Distance category 232, and a Publish category 234. The Name category 230 displays a list of individuals within the organization with whom the user being profiled is acquainted. The Distance category 232 displays a numeric representation of how well acquainted the user being profiled is with the listed individual, for primary use with search requests that are entered via the Search Screen 120, as will be described. As indicated in the Publish category 234, the user may elect whether to publish the people the user knows. The People I Know screen 188 thus allows users to track relationships that will enable the user to efficiently contact their personal network of experts within a given knowledge domain.

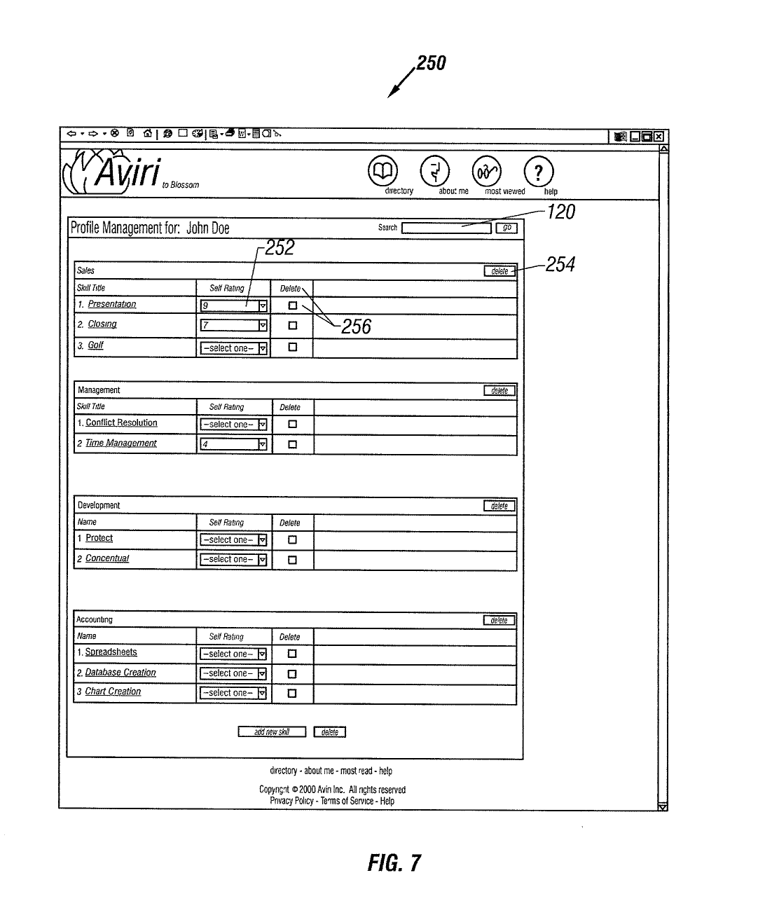

In addition, each of the Skill screen 184, Referred Skills screen 186, and People I Know screens 188 provides a Management hyperlink 240 or other means by which users can edit or review their Profile page 160. Accordingly, a Profile Management screen 250 is shown in FIG. 7, in which each of the listings of the Skill Titles 190, 210 are presented in a different screen. Pull down menus 252 or other means are preferred for allowing a user to make changes to a self-evaluation 192, 214, and means for deleting a particular knowledge domain 254 are also provided, as are means for deleting a various skill 256 that comprises a component of a various knowledge domain.

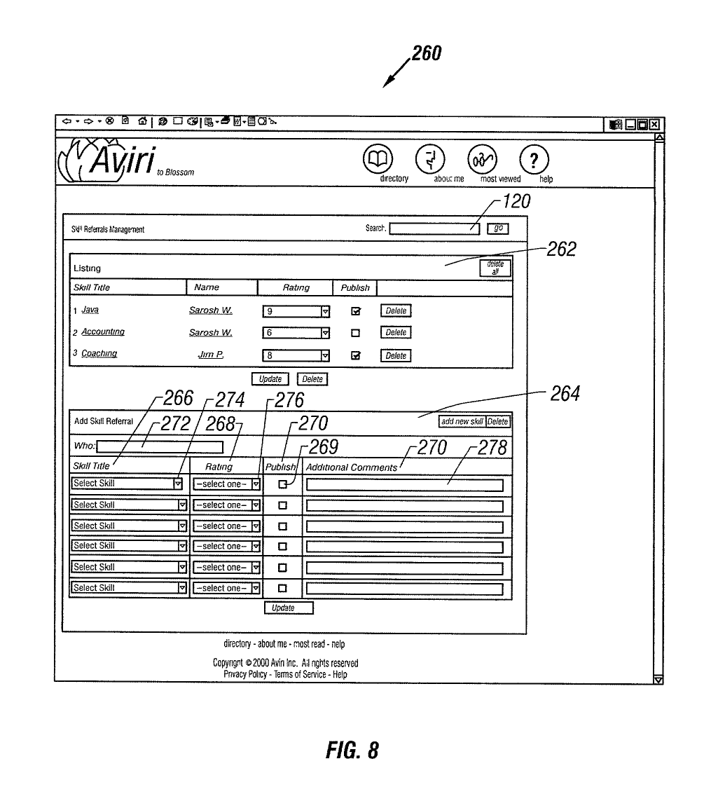

As previously described, an Others Rating category 194, displays a peer-evaluation of a user within a given knowledge domain, as adjudged by other entities within the organization. To facilitate entry of the peer-evaluation within this Others Ratings category 194, a representative Skills Referral Management page 260 is shown in FIG. 8. It includes a Listing screen 262 and an Add Skill Referral screen 264. The Add Skill Referral screen 264 is categorized by four categories, including a Skill Title category 266, a Rating category 268, a Publish category 270, and an Additional Comments category 270. In addition, a means for identifying which user is being rated is provided, for example by a text box 272 that is manual input or automatically input by a hyperlink. Pull down menus 274 or other means within the Skill Title category 266 are preferred for allowing the reviewing entity to specify the knowledge domain about which feedback is being provided. In the preferred embodiment, the peer-evaluation is rated on a numeric scale of 1-10, with higher numbers referring to a greater peer-evaluation, although the invention is not limited in this regard. Thus, pull down menus 276 or other means are preferred for allowing a user to enter this numeric rating, as is a Publish Check-Box Option 269 within the Publish category 270 and means for entering additional textual or other comments 278 within the Additional Comments category 270.

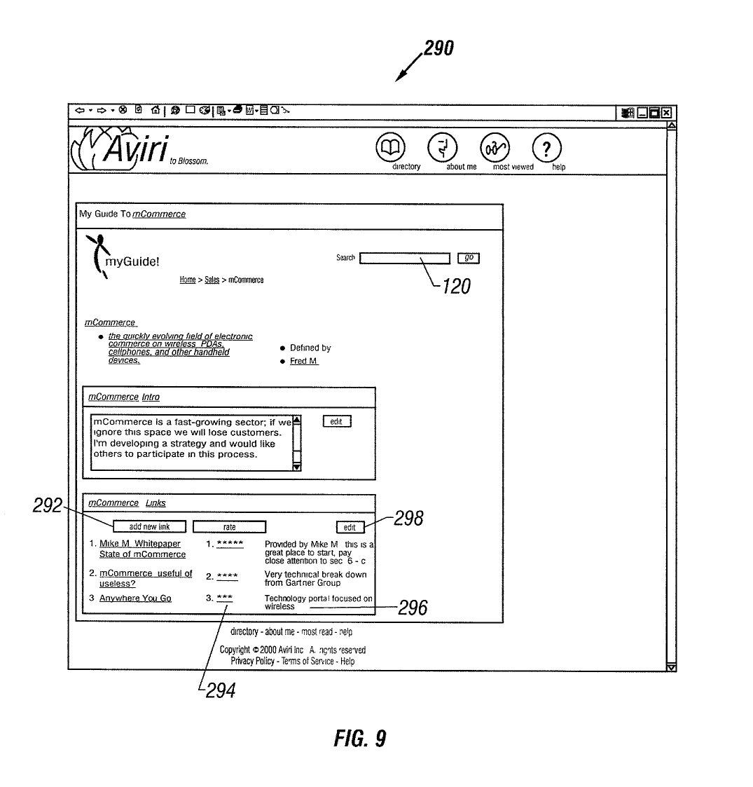

Any one expert within an organization can be sought out by more colleagues than the user can feasibly accommodate. Thus, myGuide 290, as representatively depicted in FIG. 9, allow a user to provide answers to commonly received questions about a given knowledge domain, preferably via hyperlinks to related informational sources 292 such as documents, trade journals or articles, books or magazines, web sites, or the like. Thus, if a user is unable to timely accommodate a personal request for information, the related informational sources 292 are preferably referred to in a myGuide 290. Rating fields 294 and Comment fields 296 are also provided, as are means for editing the same 298.

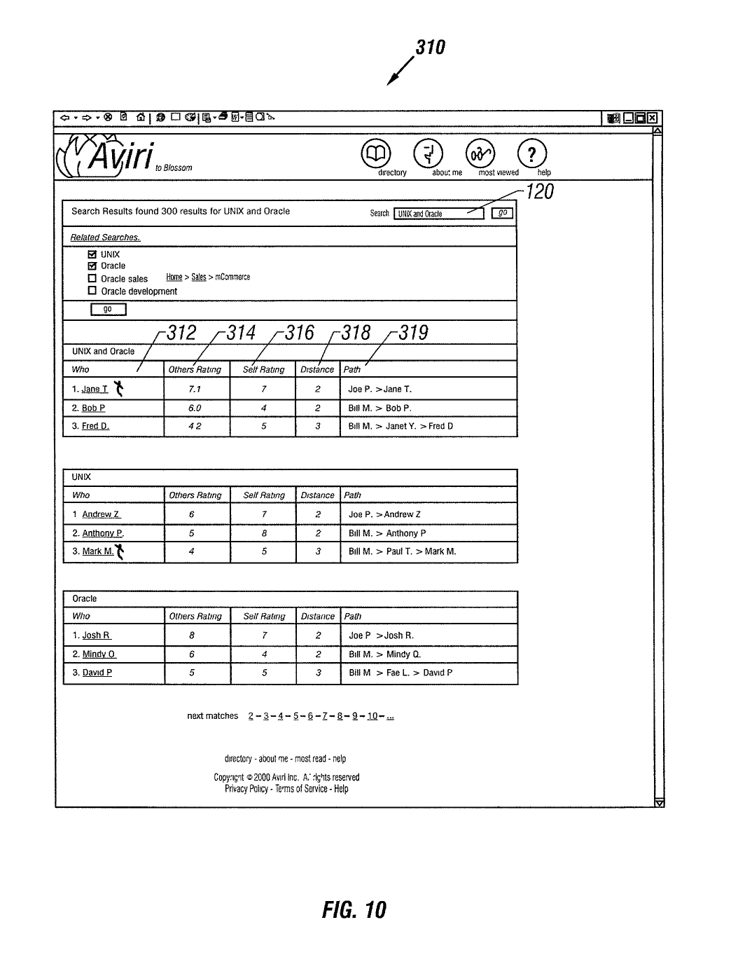

Referring now to the Search screen 120, which is preferably accessible from any of the representative display screens of FIGS. 3-9, it is preferably used in order to locate an expert or other information source in a specific knowledge domain. Standard Boolean operators are preferably employed, as understood by those skilled in the art. The Search screen 120 works in conjunction with the trust engine 52 of the application server 40, the results of which are presented on a Search Result Display screen 310, as representatively depicted in FIG. 10. The Search Result Display screen 310 is preferably categorized by five categories, including a Who category 312, an Others Rating category 314, a Self Rating category 316, a Distance category, and a Path category 319.

The Who category 312 displays the individuals that are the most highly rated within the search request parameters that are entered into the Search screen 120. The Others Rating category 314 and Self Rating category 316 display the corresponding peer-evaluations and self-evaluations. The Distance category 318 displays how many network contacts the user is removed from the identified information source, and the Path category 319 displays a preferred path connection that the user may follow in order to contact the identified individual. The Distance 318 and Path 319, as will be elaborated upon presently, are generated in conjunction with the trust engine 52, which is programmed to perform at least the following three functions: trust search, trust query, and path connections.

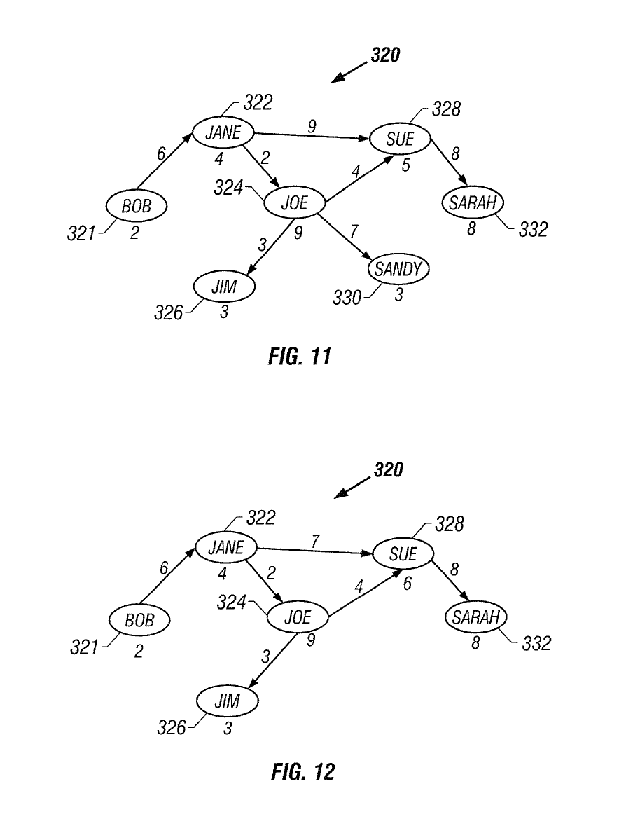

FIG. 11 depicts a representative trust network 320 for an organization. In the context of this specification, a trust network generally refers to a network of one or more relationships between one or more entities that provides an evaluation (self-evaluation and peer-evaluation) concerning a knowledge domain. Within this representative trust network, a first user 321 (“Bob”) has a self-evaluation of 2 for a given knowledge domain; a second user 322 (“Jane”) has a self-evaluation of 4; a third user 324 (“Joe”) has a self-evaluation of 9; a fourth user 326 (“Jim”) has a self-evaluation of 3; a fifth user 328 (“Sue”) has a self-evaluation of 5; a sixth user 330 (“Sandy”) has a self-evaluation of 3; and a seventh user 332 (“Sarah”) has a self-evaluation of 8. As indicated by lines connecting the users, assume further that Bob knows Jane; Jane knows Joe and Sue; Joe knows Jim, Sue, and Sandy; and Sue knows Sarah. Further, assume that Bob's peer-evaluation of Jane is 6; Jane's peer-evaluation of Joe is 2 and of Sue is 9; Joe's peer-evaluation of Jim is 3, of Sue is 4, and of Sandy is 7; and that Sue's peer-evaluation of Sarah is 8.

Regarding a “trust search,” consider that Bob is looking for someone with knowledge in a particular knowledge domain for which this is the representative trust network 320. Bob only knows Jane and his peer-evaluation of her is higher than his self-evaluation in this given knowledge domain (e.g., 6>2). Thus Bob will seek Jane's counsel. Jane, in turn, with a self-evaluation of 4, will seek Sue's counsel because her peer-evaluation of Sue is higher than her self-evaluation (e.g., 9>4); however, Jane will not seek Joe's counsel because her peer-evaluation of him is lower than her self-evaluation for this knowledge domain (e.g. 4>2). Thus, Jane will refer Bob to Sue. Sue, in turn, with a self-evaluation of 5, will seek Sarah's counsel because her peer-evaluation of Sarah is higher than her self-evaluation (e.g. 8>5). Thus, Sue will continue to refer Bob to Sarah, who, since the end of the trust chain has been reached, is the person Bob should ultimately seek to provide the desired counsel. This model assumes a transitive rule of trust in which if user A trusts user B who trusts user C, user A is therefore justified in trusting user C.

Knowing that Sarah is the best person to counsel Bob, Bob also now knows that to contact her, his personal path connection takes him through Jane through Sue to Sarah. As understood by those skilled in the art, a generic implementation of the above methodology will, of course, preferably allow for the return of the top n candidates in order to allow Bob the widest possible range of options within the organization, with n being a pre-specified number, and presenting Bob with multiple path connections 319 from which he may subjectively choose, a most trusted path connection 319 comprising the highest peer-evaluation path.

Regarding a “trust query,” consider that Bob is contemplating how much he should trust an unknown referral, such as Sandy in the representative example of FIG. 11. The only path connection from Bob to Sandy is via Bob to Jane to Joe to Sandy. Assuming that all weights are normalized such that level 5 refers to “same as me” and that Bob's peer-evaluation of Jane is 6, whatever Jane tells Bob is adjusted accordingly. However, since Jane's peer-evaluation of Joe is 2, whatever Joe tells Bob must be discounted by a function f(x,y) where x represents Bob's peer-evaluation of Jane and y represents Jane's peer-evaluation of Joe. Next, since Joe's peer-evaluation of Sandy is 7, whatever Sandy tells Bob is adjusted accordingly, namely by a function g(w,z) where w=f(x,y) and z represents Joe's peer-evaluation of Sandy. Thus, whatever Sandy tells Bob will be adjusted as a composite function g( f(x,y), z), where functions f and g are pre-defined based on a transitive rule of trust understood by those skilled in the art. In a preferred embodiment, the functions f and g can be defined by the user according to how the user desires to perform searches or in accordance with other criteria, such as a drop-off or other attenuation factor that accounts for absolute distances from a starting node. Regarding “path discovery,” considering finding path connections from Jane to Sarah, of which there are two in the representative example of FIG. 11, namely Jane via Sue to Sarah, or Jane via Joe via Sue to Sarah. In the preferred embodiment, the user will specify whether both paths should be presented or only the shortest path. As understood by those skilled in the art, a generic implementation of the above methodology will, of course, preferably allow for the trust engine to return the n shortest path connections, the first n path connections, the n most trusted path connections, and other variations, all of which are preferably displayed to the user via the Search Result Display screen 310 of FIG. 10.

Referring now to FIG. 12, one of the peer-evaluations of the trust network 320 has been modified by one of the entities. More specifically, this figure depicts one method of learning that the trust network 320 will provide, e.g., by providing new self-evaluations and new peer-evaluations. For instance, the peer-evaluation from Jane to Sue has been modified from 9 to 7, and the self-evaluation of Sue has changed from 5 to 6.

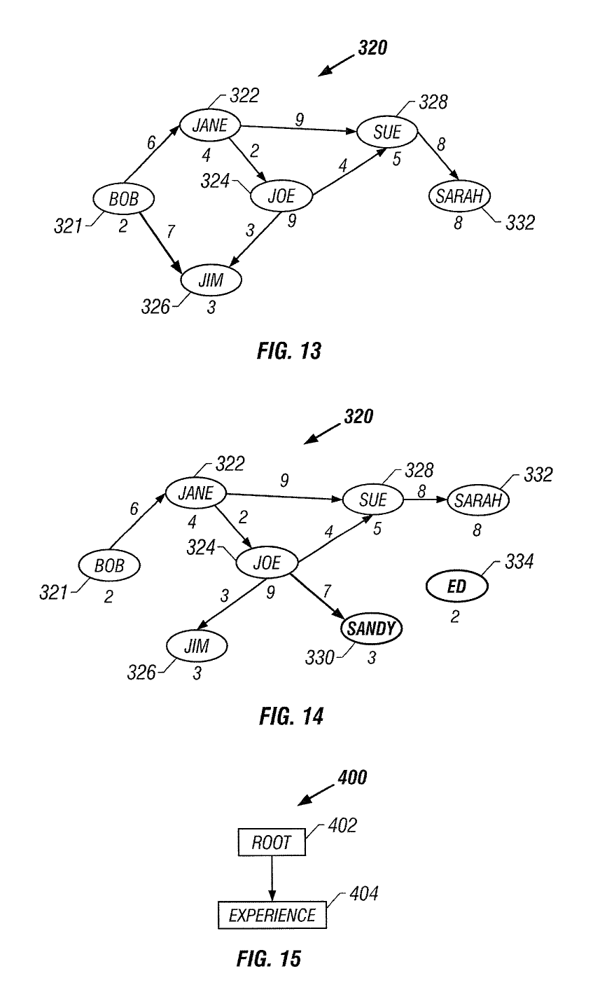

Referring now to FIG. 13, this figures depicts the trust network 320 learning through the acquisition of a new peer-evaluation from Bob to Jim, specifically at a trust rating of 7. In practice, this may reflect Bob interacting with Jim and deciding to trust him, or of Bob adding his pre-existing trust of Jim into the trust network 320.

Referring now to FIG. 14, this figure depicts the trust network 320 learning through the acquisition of new entities. More specifically, assuming that Sandy had not previously been a part of the trust network 320 but was recently added by Joe, his peer-evaluation of her may be a numeric value of 7, but since she was just recently added to the trust network 320, she may not yet have had an opportunity to establish a self-evaluation. Similarly, if an eighth user 334 (“Ed”) has just added himself to the trust network 320 with a self-evaluation of 2, no other entities may yet have had an opportunity to interact with Ed and thus, there are no current peer-evaluations of him.

Referring now to FIG. 15, a representative knowledge hierarchy 400 is depicted. More specifically, the knowledge hierarchy 400 is comprised of a first knowledge domain 402 (“Root”) and a second knowledge domain 404 (“Experience”). The knowledge domains are hierarchically ordered with the Experience knowledge domain being a subset of the Root knowledge domain. In a preferred embodiment, a trust network 320 is established for each of the knowledge domains apart from the Root domain, although the invention is not limited in this regard, and provides that at least one trust network 320 is established for at least one of the knowledge domains. In this example, a trust network 320 is established for the Experience knowledge domain, the trust network 320 being input incrementally as the various users are added to the system, preferably via the users interacting with the one or more primary servers 14 through the screen displays of FIG. 3-10, including FIG. 8. In this way, the database is established and contains one or more knowledge domains that contain one or more items having at least one element in common, the database further containing one or more trust networks 320 associated with at least one of the knowledge domains. In this example, the Experience knowledge domain preferably represents general trust levels of the entities of the organization, which are useful for determining whether or not a specified entity is generally adjudged to be trustworthy.

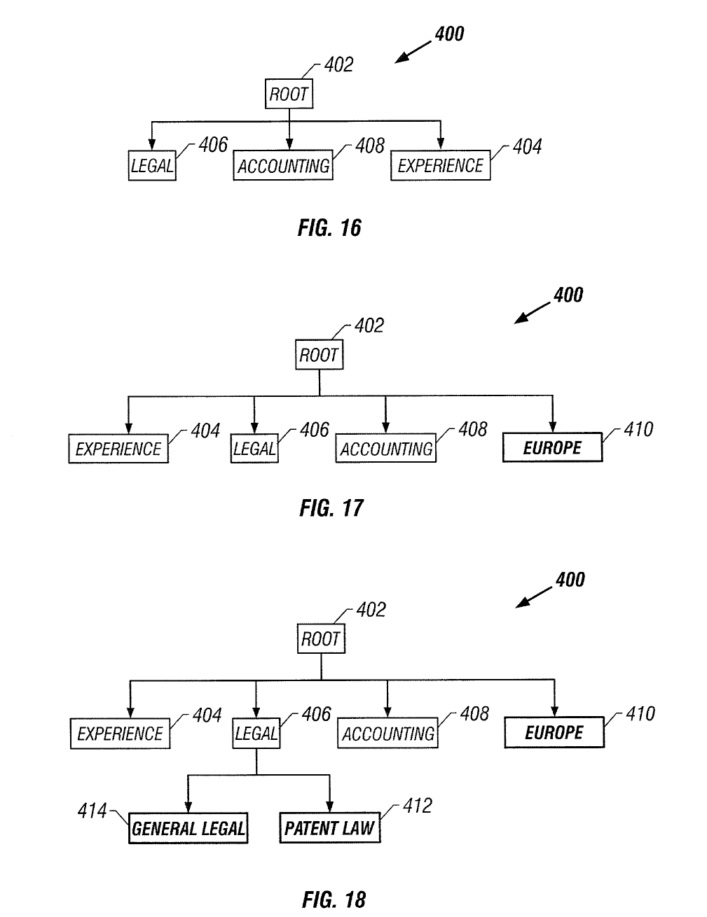

As representatively depicted in FIG. 16, a third knowledge domain 406 (“Legal”) and fourth knowledge domain 408 (“Accounting”) have been added to the trust network 320. In representative FIG. 17, a fifth knowledge domain 410 (“Europe”) has also been added to the trust network 320. These Legal, Accounting, and Europe knowledge domains have preferably been added to the system in response to user search requests that are preferably input at the Search screen 120 displayed by the browser at the client 12. When a new knowledge domain is input into the Search screen 120 that was not previously entered into the system, the primary server 14 is preferably programmed to add the new knowledge domain to the knowledge hierarchy 400. In addition, new knowledge domains are also preferably added to the knowledge hierarchy 400 by an entity seeking to provide a self-evaluation in this new knowledge domain or by another entity seeking to provide a peer-evaluation in this new knowledge domain.

In this way, knowledge domains are established in response to search requests at the Search screen 120, or by the Add Skill Referral screen 264 of FIG. 8. In the preferred embodiment, the knowledge hierarchy 400 allows as many nested knowledge domains as memory and disk space of the primary server 14 allow.

In the preferred embodiment, the hierarchical ordering of the knowledge hierarchy 400 is modified and established in response to the search requests. For example, in the representative FIG. 18, a sixth knowledge domain 412 (“Patent Law”) is added to the Legal knowledge domain 406 in response to the search requests. In the depicted embodiment, since no other knowledge domain children of the Legal knowledge domain yet exist, the knowledge hierarchy 400 is preferably programmed to move the trust network 320 previously associated with the Legal knowledge domain to an association with a new, automatically created seventh knowledge domain 414 (“General Legal”). This functionality allows the users of the inventive arrangements to still identify entities possessing skills related to the General Legal knowledge domain, yet also identify multi-specialists possessing skills related to the Patent Law knowledge domain. Multi-specialists are distinguished from generalists by the former's on-going commitment to learning new specialties as they are identified by the knowledge hierarchy 400 and added as new children of the “Legal” knowledge domain. Preferably, a new trust network 320 for the General Legal knowledge domain is created and associated with the original Legal knowledge domain. In addition, the new General Legal knowledge domain preferably cannot be subdivided into further additional knowledge domain children because the General Legal knowledge domain preferably comprises a catch-all knowledge domain for any general parent skills that are unable to be identified in a specialized sibling knowledge domain such as the Patent Law knowledge domain. In this representative example, the General Legal knowledge domain thus entails the legal skills of the entities that do not fall within the Patent Law knowledge domain.

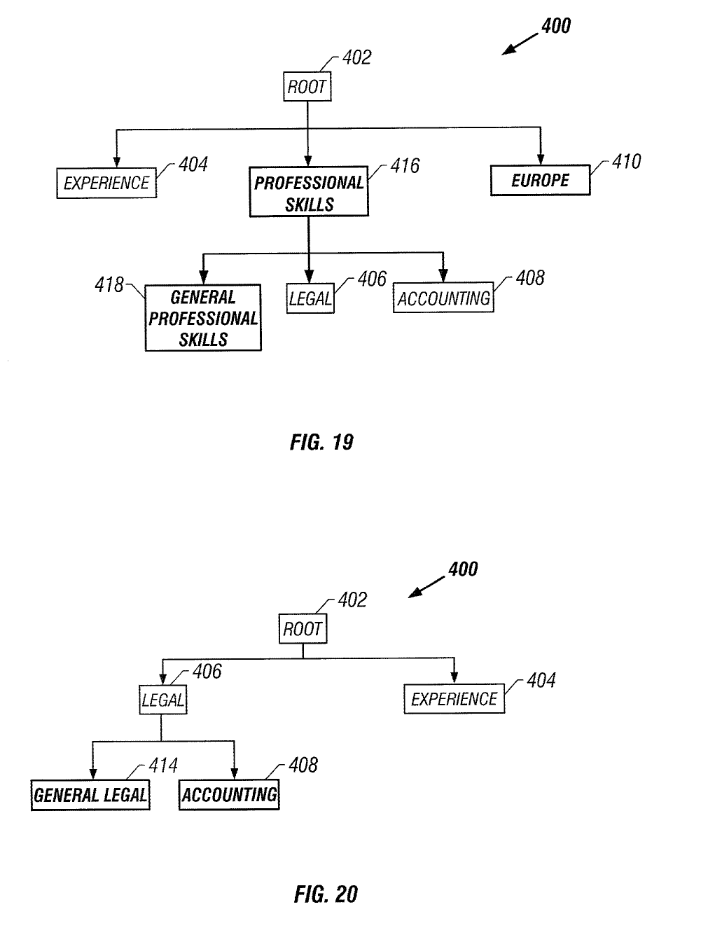

As representatively depicted in FIG. 19, children knowledge domains may also be generalized into one or more parent knowledge domains. For example, this figure shows a preferred embodiment of the generalization of the Legal and Accounting children knowledge domains, which are now subsumed under a new eighth parent knowledge domain 416 (“Professional Skills”). In a preferred embodiment, the new parent Professional Skills knowledge domain automatically creates a new ninth child knowledge domain 418 (“General Professional Skills”) to accommodate other knowledge domain skills that do not fall within the Legal and Accounting knowledge domains of the Professional knowledge domain.

Furthermore, as representatively depicted by FIG. 20, various knowledge domains may be relocated within the knowledge hierarchy 400. For example, this figure depicts the process of the knowledge hierarchy 400 learning via a knowledge domain being relocated in the knowledge hierarchy 400 in response to the search requests of the users. For example, the Accounting knowledge domain moves from a child of the Root knowledge domain to a child of the Legal knowledge domain in this figure. If the Legal knowledge domain previously had no children knowledge domains, the General Legal knowledge domain 414 is preferably created automatically as previously described, the trust network 320 previously associated with the Legal knowledge domain now being associated with the General Legal knowledge domain.

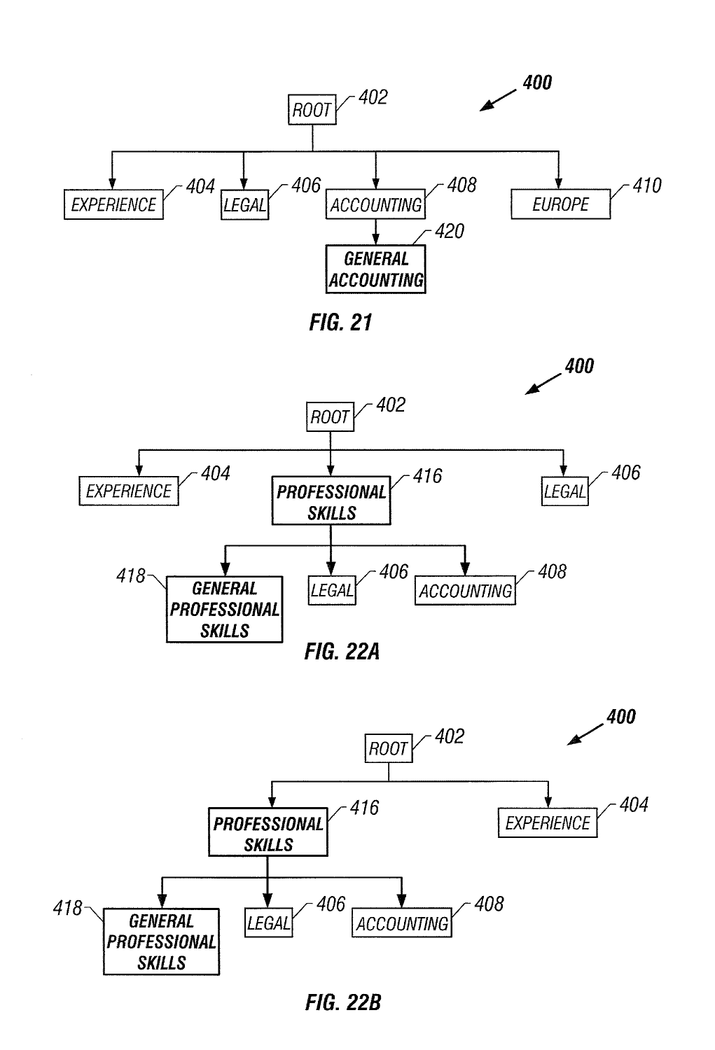

In addition, as representatively depicted by FIG. 21, previously unrelated knowledge domains can also be linked within the knowledge hierarchy 400. For example, in the depicted figure, this would preferably enable the creation of a new tenth knowledge domain 420 (“General Accounting”), which would be a child of the original Accounting knowledge domain. In a preferred embodiment, the trust network 320 that was previously associated with the Accounting knowledge domain is then associated with the new General Accounting knowledge domain. Other preferred linking embodiments do not require establishing a General Skills knowledge domain, yet perform linking in substantially the same way, but without creating the new General Accounting knowledge domain and reassociating therewith the trust network 320 of the Accounting knowledge domain.

Finally, as representatively depicted by FIG. 22, various knowledge domains are merged together. For example, this figure depicts the proces of the knowledge hierarchy 400 learning via one knowledge domain merging with another knowledge domain within the knowledge hierarchy 400. More specifically, the Legal knowledge domain under the Root knowledge domain has merged, preferably in response to various search requests, with the Legal knowledge domain under the Professional Skills knowledge domain. This is how the inventive methods and systems are managed as the knowledge hierarchy 400 learns which knowledge domains are more or less important to the users of the system.

The spirit of the present invention is not limited to any of the various embodiments described above. Rather, the details and features of exemplary embodiments have been disclosed as required. Without departing from the scope of this invention, other modifications will therefore be apparent to those skilled in the art. Thus, it must be understood that the detailed description of the invention and drawings were intended as illustrative only, and not by way of limitation.

To apprise the public of the scope of this invention, the following claims are made:

What is claimed is:

1. A method for identifying one or more information sources based on one or more search requests from a user, said method comprising steps of:
a. establishing a database containing:
one or more knowledge domains wherein at least one of said knowledge domains contains a grouping of one or more items having at least one commonality;
one or more trust networks associated with at least one of said knowledge domains wherein at least one of said trust networks comprises one or more evaluations of said information sources, said evaluations being provided to said database by one or more entities;
b. applying one or more search requests to said database;
c. accessing said database in response to said search requests; and
d. providing a response to said search requests.

2. The method of claim 1 wherein said database comprises a plurality of databases.

3. The method of claim 1 wherein at least one of said knowledge domains is established in response to said search requests.

4. The method of claim 1 wherein at least one of said knowledge domains is modified in response to said search requests.

5. The method of claim 1 wherein said knowledge domains are arranged by a hierarchical ordering.

6. The method of claim 5 wherein said hierarchical ordering is established in response to said search requests.

7. The method of claim 5 wherein said hierarchical ordering is modified in response to said search requests.

8. The method of claim 1 wherein at least one of said evaluations is modified by at least one of said entities.

9. The method of claim 1 wherein at least one of said evaluations comprises a self-evaluation by one of said entities.

10. The method of claim 1 wherein at least one of said evaluations comprises a peer-evaluation by one of said entities.

11. The method of claim 10 wherein said peer-evaluation comprises a composite peer-evaluation.

12. The method of claim 1 wherein at least one of said evaluations comprises a self-evaluation by one of said entities and at least one of said evaluations comprises a peer-evaluation by one of said entities.

13. The method of claim 12 wherein said peer-evaluation comprises a composite peer-evaluation.

14. The method of claim 1 wherein the step of providing a response comprises establishing one or more path connections through said trust networks.

15. The method of claim 14 wherein establishing one or more path connections comprises establishing one or more most trusted path connections.

16. The method of claim 14 wherein establishing one or more path connections comprises establishing said path connections in response to said evaluations.

17. The method of claim 14 further comprising displaying said path connections through said trust networks.

18. The method of claim 17 wherein displaying said path connections comprises displaying said path connections to said user.

19. A machine readable storage having stored thereon one or more computer programs for enabling a user to identify one or more information sources based on one or more search requests by said user, said computer programs having one or more code sections executable by one or more machines for causing said machines to perform steps of:
a. establishing a database containing:
one or more knowledge domains wherein at least one of said knowledge domains contains a grouping of one or more items having at least one commonality;
one or more trust networks associated with at least one of said knowledge domains wherein at least one of said trust networks comprises one or more evaluations of said information sources, said evaluations being provided to said database by one or more entities;
b. applying one or more search requests to said database;
c. accessing said database in response to said search requests; and
d. providing a response to said requests.
